(19) United States
(12) Patent Application Publication
(10) Pub. No.: US 2016/0149948 A1
(43) Pub. Date: May 26, 2016

(54) Automated Cyber Threat Mitigation Coordinator

(71) Applicant: Cybersponse, Inc., Scottsdale, AZ (US)

(72) Inventors: Joseph Loomis, Chandler, AZ (US); Christopher Coriale, Phoenix, AZ (US)

(73) Assignee: Cybersponse, Inc., Scottsdale, AZ (US)

(21) Appl. No.: 14/866,198

(22) Filed: Sep. 25, 2015

Related U.S. Application Data
(60) Provisional application No. 62/055,436, filed on Sep. 25, 2014.

(51) Int. Cl. H04L 29/06

(52) U.S. Cl. CPC H04L 63/1441

(57) ABSTRACT

Various computer systems and networks may benefit from an automated cyber threat mitigation coordinator. A related method can include receiving, at a server, data from at least one first sensor or tool. The data can be configured to inform the server of an actual or potential threat to at least one computer system or network. The method can also include processing, by the server, the data to determine at least one confirmation action to be taken with respect to the data. The method can further include performing, at the server, the determined confirmation action. The action can include communicating with at least one second sensor or tool. The method can additionally include receiving, at the server, a response to the communicating with the at least one second sensor or tool. The method can also include generating and outputting consolidated data to a user of the server, based on the response.

### CROSS REFERENCE TO RELATED APPLICATIONS

This application is related to and claims the benefit and priority of U.S. Provisional Patent Application No. 62/055,436, filed Sep. 25, 2014, the entirety of which is hereby incorporated herein by reference. Although priority is not claimed, the present application also incorporates by reference U.S. Patent Application Publication No. 2014/0278664, although the definitions set forth therein should be taken as examples and not limitations for the purposes of this application.

### BACKGROUND

1. Field

Various computer systems and networks may benefit from suitable security systems. For example, certain systems may benefit from an automated cyber threat mitigation coordinator.

2. Description of the Related Art

Cybersecurity threats have become an ever-present concern in the modern global economy. As these threats have become more varied and complex, so too have the tools used to detect and mitigate them. A modern cybersecurity professional may need to use dozens of tools for each security event and incident. With potentially thousands of security events and incidents to be dealt with each day and a marked dearth of qualified professionals to handle them, Security Operations Centers (SOCs) are finding themselves quickly overrun and unable to stay on top of emerging threats.

### SUMMARY

According to certain embodiments, a method can include receiving, at a server, data from at least one first sensor or tool. The data can be configured to inform the server of an actual or potential threat to at least one computer system or network. The method can also include processing, by the server, the data to determine at least one confirmation action to be taken with respect to the data. The method can further include performing, at the server, the determined confirmation action. The action can also include communicating with at least one second sensor or tool. The method can additionally include receiving, at the server, a response to the communicating with the at least one second sensor or tool. The method can also include generating and outputting consolidated data to a user of the server, based on the response.

In certain embodiments, an apparatus can include at least one processor and at least one memory including computer program code. The at least one memory and the computer program code can be configured to, with the at least one processor, cause the apparatus at least to receive data from at least one first sensor or tool. The data can be configured to inform a server of an actual or potential threat to at least one computer system or network. The at least one memory and the computer program code can also be configured to, with the at least one processor, cause the apparatus at least to process the data to determine at least one confirmation action to be taken with respect to the data. The at least one memory and the computer program code can further be configured to, with the at least one processor, cause the apparatus at least to perform the determined confirmation action. The action can include communicating with at least one second sensor or tool. The at least one memory and the computer program code can additionally be configured to, with the at least one processor, cause the apparatus at least to receive a response to the communicating with the at least one second sensor or tool. The at least one memory and the computer program code can also be configured to, with the at least one processor, cause the apparatus at least to generate and output consolidated data to a user of the server, based on the response.

A non-transitory computer-readable medium can be encoded with instructions that, when executed in hardware, perform a process. The process can include receiving, at a server, data from at least one first sensor or tool. The data can be configured to inform the server of an actual or potential threat to at least one computer system or network. The process can also include processing, by the server, the data to determine at least one confirmation action to be taken with respect to the data. The process can further include performing, at the server, the determined confirmation action. The action can include communicating with at least one second sensor or tool. The process can additionally include receiving, at the server, a response to the communicating with the at least one second sensor or tool. The process can also include generating and outputting consolidated data to a user of the server, based on the response.

### BRIEF DESCRIPTION OF THE DRAWINGS

For proper understanding of the invention, reference should be made to the accompanying drawings, wherein:

FIG. 1 illustrates processes related to a high-level overview of a coordinator system according to certain embodiments of the present invention.

FIG. 2 illustrates methods according to certain embodiments of the present invention.

### DETAILED DESCRIPTION

Certain embodiments of the present invention relate to a computer system configured to automate the analysis and mitigation processes of handling security events and incidents. The computer system can be configured to have pre-defined Application Programming Interface (API) connectivity with a multitude of other security tools and sensors. These tools and sensors may include Security Incident and Event Management (SIEM) tools, Intrusion Detection Systems (IDS), malware scanners, threat intelligence feeds, malware forensic tools, firewalls, web servers, servers, databases, and other tools and sensors that a SOC may wish to utilize, including any cyber-security tools.

The computer system disclosed herein may be configured to receive data from any of the tools or sensors and automatically begin a process of parsing the data received and, in turn, sending relevant portions of the data to other connected tools and sensors through the API integration. The computer system can be further configured to receive new data from the subsequent sensors and tools and continue the process of utilizing all requested tools and sensors through a pre-defined workflow.

As the data is received by the various tools and sensors, relevant portions of the received data can be inserted into an “event display or “incident display” for the end user to visually see the feedback from the tools and sensors and to build a more complete picture of the security event or incident for a SOC team member. This may save SOC teams significant time from having to manually enter data into the tools or sensors and the need to actually observe the feedback for reporting in a separate incident handling platform.

Certain embodiments of the present invention may be part of a larger incident response scheme or system, wherein event and incident data can be received by both external and internal sources.

More particularly, certain embodiments relate to a method and system for automating the analysis and data gathering functions of a SOC team or other personnel involved in securing computer networks and systems. In view of the saved time for security personnel using the embodiments, incidents may be handled more quickly and effectively.

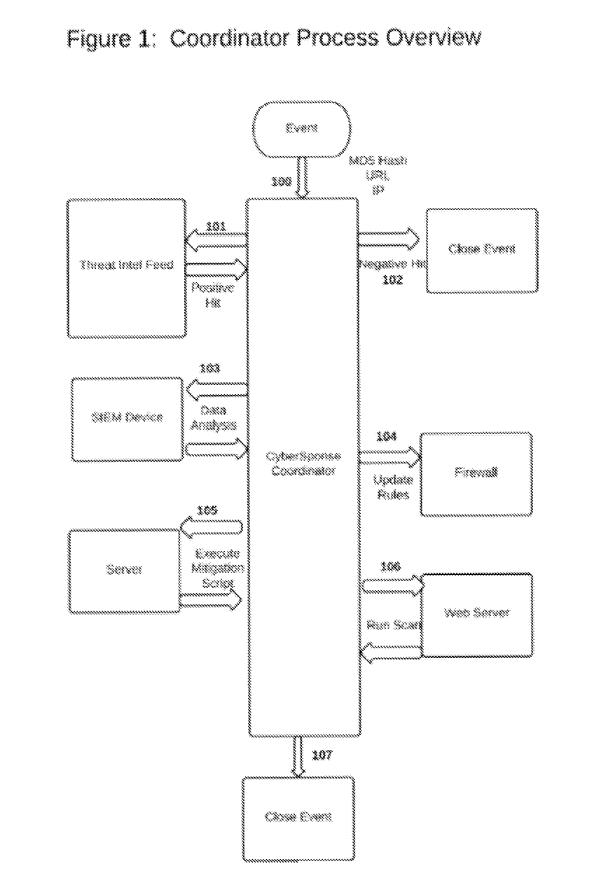

FIG. 1 illustrates processes related to a high-level overview of a coordinator system according to certain embodiments. In step 100, the coordinator, a computer system having a processor, non-transitory processor-readable storage, a database, and a screen, can receive event or incident data from a connected tool or sensor. The coordinator can also be embodied in other ways. For example, the coordinator can be a cluster computing system or a cloud computing system. The system can have multiple processors with processes running sequentially or in parallel. In certain embodiments, the system may be a single application specific integrated circuit and in other embodiments the system may be built from a variety of components that may be placed in one or multiple enclosures.

These tools or sensors may include one or more of any of: a STEM tool, an IDS, a malware scanner, a threat intelligence feed, a forensic tool, a firewall, a web server, a server, a database or other tools or sensors.

In certain embodiments, a SIEM detection device can provide the initial event or incident data to the coordinator. Such initial event or incident data may include an MD5 Hash, a URL, or an IP address associated with a detected potential threat.

After receiving the data in step 100, the coordinator can process the data and determine, based on a predefined workflow, what next tool or sensor to utilize in the handling of the event or incident. This predefined workflow can be created by an end user using a visual interface with predefined API definitions for all configured tools and sensors. The user may select the order in which he or she wishes to run the process and save this in the coordinator database for future automated use. In certain embodiments, the incoming MD5 Hash, URL, or IP address can be sent to an external threat intelligence feed for processing using a pre-configured API integration. The threat intelligence feed can be configured to conduct a search on the MD5 Hash, URL, or IP address and communicate the results back to the coordinator through the API integration.

In certain embodiments, if the results from the threat intelligence feed result in no positive results, the coordinator can close the event or incident, as in step 102. Other embodiments may eliminate this termination step 102 and continue with processing through the coordinator.

If the results of the threat intelligence feed return with a positive finding of a threat, the coordinator can continue with its analysis through a pre-defined workflow to the next configured tool or sensor. In certain embodiments, further data analysis can be performed by either the same SIEM tool that produced the initial data in step 100 or by one or more second, unique, SIEM tool(s). The data sent by the coordinator in this step 103 can be new threat intelligence data, received by the threat intelligence feed. The connection between the coordinator and the SIEM device in this step 103 may be through the same pre-defined API integration.

After the new data set is sent from the SIEM device in step 103, the coordinator can create a new rule set for a connected firewall, including MD5 hashes, uniform resource locators (URLs), or internet protocol (IP) addresses that returned with positive results from any SIEM tool or threat intelligence feeds involved in the process. These new rule sets can be sent to the API-connected firewall in step 104, thus eliminating the need for manual configuration of the new firewall rules.

Simultaneously or sequentially with step 104, the coordinator can use API-connected communications with agent software or other scripts pre-configured to accept remote commands to send commands to execute mitigation processes on the same or a separate server. In certain embodiments, the commands sent via step 104 can contain data, such as an MD5 hash, to provide the agent software or scripts with the necessary information to mitigate and/or eliminate malware, viruses, or the like automatically. In certain embodiments, when the agent software or remote script is complete, it can send a notification via the API integration to the coordinator, alerting the coordinator of such completion.

After such mitigation scripts have been completed (or the command for execution has been sent), the coordinator can send, in step 106, an execution command via API integration to a malware or other scanner on a server. The server may be the server in step 105, a separate web server, as shown in FIG. 1, or any combination of additional servers. After the scan is complete, the server having the scanner can send the results data back to the coordinator.

If the results of the scan in step 106 are returned negative, the event or incident can be automatically closed, as resolved in step 107. If the results are returned positive, the data may continue to be processed by the coordinator in any combination of pre-defined workflows or may still terminate in step 107, depending on the configuration of the coordinator.

Throughout the coordinator process, any data received by any tool or sensor in any step can be populated in an incident display or an event display to enable an end user to view the progress of the event or incident and make manual adjustments at any time. Without input from the user during the operation of the coordinator, the coordinator can continue its processes along whatever pre-configured and defined workflows the end user has stored in the database, enabling fully automated operation of a SOC.

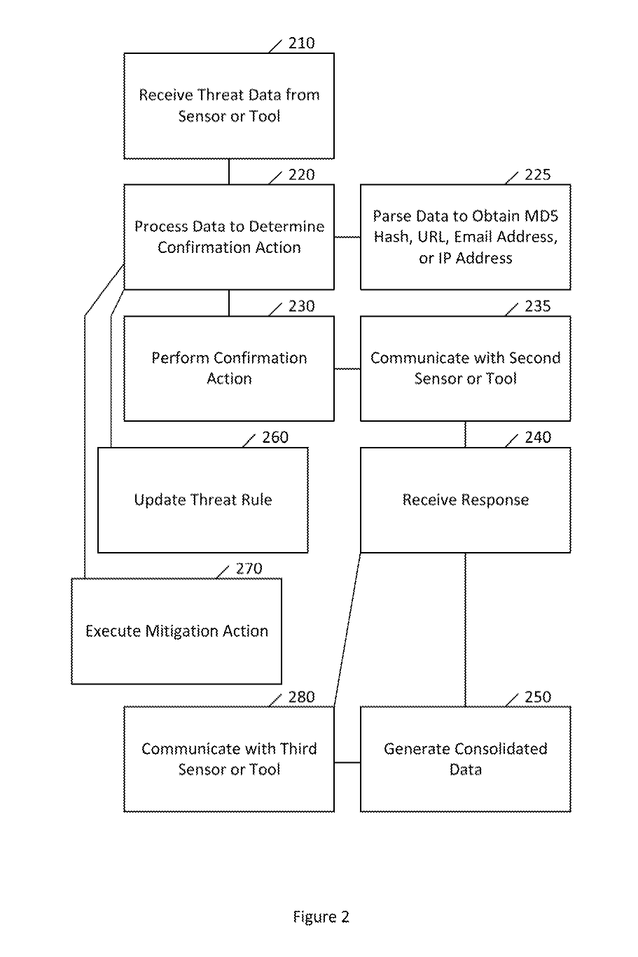

FIG. 2 illustrates methods according to certain embodiments of the present invention. As shown in FIG. 2, a method can include, at 210, receiving, at a server, data from at least one first sensor or tool. The data can be configured to inform the server of an actual or potential threat to at least one computer system or network. The server can be, but does not have to be, a part of the computer system or network under threat. The at least one first sensor or tool can be or include a SIEM tool.

The method can also include, at 220, processing, by the server, the data to determine at least one confirmation action to be taken with respect to the data. The confirmation action can involve any action taken to confirm that the actual or potential threat is an actual or potential threat. Such actions can include, for example, parsing relevant data and either searching for the relevant data in a tool or using the relevant data as an input for processing in a tool. The action can also involve checking historical records to compare the current data or requesting the input of the same or other systems. The processing can include, at 225, parsing the data to obtain at least one of an MD5 hash, a URL, an email address, or an IP address.

The method can further include, at 230, performing, at the server, the determined confirmation action. The action can include, at 235, communicating with at least one second sensor or tool. For example, the communicating can include communicating with a threat intelligence feed. The threat intelligence feed may include an email feed, an RSS feed, an API-connected feed or the like. The first sensor or tool can be the same as or different from the second sensor or tool. Other confirmation actions can also be performed.

The method can additionally include, at 240, receiving, at the server, a response to the communicating with the at least one second sensor or tool. The server can then process this response similar to the way that the original data was processed

The method can also include, at 250, generating and outputting consolidated data to a user of the server, based on the response. This consolidated data may include threat intelligence data. The consolidated data can be based on a comparison between the response and the data.

The method can also include, at 260, updating at least one threat rule based on the processing or the response. For example, a sensitivity or threshold for future use by associated tools can be increased or decreased based on processing the data. A new threat rule can be generated to watch for similar data in the future. Other updates are also permitted.

The method can further include, at 270, executing a mitigation action based on the processing or the response. The mitigation action may include remote locking a terminal, remotely wiping a disk drive, switching to a different firewall or proxy server, requiring a user to re-authenticate, or any other mitigation action desired.

The method can additionally include, at 280, when the response meets a predetermined criterion, soliciting and receiving a further response from a third sensor or tool regarding the data, the response, or both the data and the response.

The embodiments of the present invention, as disclosed herein, may be practiced with steps in a different order, and/or with hardware elements in configurations which are different than those which are disclosed. Therefore, although the invention has been described based upon these example embodiments, certain modifications, variations, and alternative constructions should be apparent, while remaining within the spirit and scope of the invention. In order to determine the metes and bounds of the invention, therefore, reference should be made to the appended claims.

We claim:

1. A method, comprising:
receiving, at a server, data from at least one first sensor or tool, wherein the data is configured to inform the server of an actual or potential threat to at least one computer system or network;
processing, by the server, the data to determine at least one confirmation action to be taken with respect to the data;
performing, at the server, the determined confirmation action, wherein the action comprises communicating with at least one second sensor or tool;
receiving, at the server, a response to the communicating with the at least one second sensor or tool; and
generating and outputting consolidated data to a user of the server, based on the response.

2. The method of claim 1, wherein the at least one first sensor or tool comprises a STEM tool.

3. The method of claim 1, wherein the processing comprises parsing the data to obtain at least one of an MD5 hash, a URL, an email address, or an IP address.

4. The method of claim 1, wherein the communicating comprises communicating with a threat intelligence feed.

5. The method of claim 1, wherein the consolidated data is based on a comparison between the response and the data.

6. The method of claim 1, wherein the first sensor or tool is the same as the second sensor or tool.

7. The method of claim 1, further comprising:
updating at least one threat rule based on the processing or the response.

8. The method of claim 1, further comprising:
executing a mitigation action based on the processing or the response.

9. The method of claim 1, further comprising:
when the response meets a predetermined criterion, soliciting and receiving a further response from a third sensor or tool regarding the data, the response, or both the data and the response.

10. An apparatus, comprising:
at least one processor; and
at least one memory including computer program code,
wherein the at least one memory and the computer program code are configured to, with the at least one processor, cause the apparatus at least to:
receive data from at least one first sensor or tool, wherein the data is configured to inform a server of an actual or potential threat to at least one computer system or network;
process the data to determine at least one confirmation action to be taken with respect to the data;
perform the determined confirmation action, wherein the action comprises communicating with at least one second sensor or tool;
receive a response to the communicating with the at least one second sensor or tool; and
generate and output consolidated data to a user of the server, based on the response.

11. The apparatus of claim 10, wherein the at least one first sensor or tool comprises a STEM tool.

12. The apparatus of claim 10, wherein the at least one memory and the computer program code are configured to, with the at least one processor, cause the apparatus at least to parse the data to obtain at least one of an MD5 hash, a URL, an email address, or an IP address.

13. The apparatus of claim 10, wherein the at least one memory and the computer program code are configured to, with the at least one processor, cause the apparatus at least to communicate with a threat intelligence feed.

14. The apparatus of claim 10, wherein the consolidated data is based on a comparison between the response and the data.

15. The apparatus of claim 10, wherein the first sensor or tool is the same as the second sensor or tool.

16. The apparatus of claim 10, wherein the at least one memory and the computer program code are configured to, with the at least one processor, cause the apparatus at least to update at least one threat rule based on the processing or the response.

17. The apparatus of claim 10, wherein the at least one memory and the computer program code are configured to, with the at least one processor, cause the apparatus at least to execute a mitigation action based on the processing or the response.

18. The apparatus of claim 10, wherein the at least one memory and the computer program code are configured to, with the at least one processor, cause the apparatus at least to, when the response meets a predetermined criterion, solicit and receive a further response from a third sensor or tool regarding the data, the response, or both the data and the response.

19. A non-transitory computer-readable medium encoded with instructions that, when executed in hardware, perform a process, the process comprising:
receiving, at a server, data from at least one first sensor or tool, wherein the data is configured to inform the server of an actual or potential threat to at least one computer system or network;
processing, by the server, the data to determine at least one confirmation action to be taken with respect to the data;
performing, at the server, the determined confirmation action, wherein the action comprises communicating with at least one second sensor or tool;
receiving, at the server, a response to the communicating with the at least one second sensor or tool; and
generating and outputting consolidated data to a user of the server, based on the response.

20. The non-transitory computer-readable medium of claim 19, wherein the processing comprises parsing the data to obtain at least one of an MD5 hash, a URL, an email address, or an IP address.
